(19) United States
(12) Patent Application Publication
(10) Pub. No.: US 2006/0083391 A1
(43) Pub. Date: Apr. 20, 2006

(54) Multichannel sound reproduction apparatus and multichannel sound adjustment method

(76) Inventors: Ikuoh Nishida, Hyogo (JP); Ryoji Suzuki, Nara (JP)

Correspondence Address: MCDERMOTT WILL & EMERY LLP, 600 13TH STREET, N.W., WASHINGTON, DC, 20005-3096, US

(21) Appl. No.: 11/251,898

(22) Filed: Oct. 18, 2005

(30) Foreign Application Priority Data
Oct. 20, 2004 (JP) 2004-305468

(51) Int. Cl. H04R 3/00; H04R 29/00

(52) U.S. Cl. 381/96; 381/59

(57) ABSTRACT

Loudspeakers are sequentially selected by input/output switches and switched to the sound output mode, while the other non-selected loudspeakers are switched to the sound input mode. A loudspeaker in the sound output mode emits a test sound, and the other loudspeakers function as microphones to collect the test sound. The delay time and signal level of a reproduction sound signal are controlled based on a sound signal generated according to the collected test sound.

### BACKGROUND OF THE INVENTION

1. Field of the Invention

The present invention relates to a multichannel sound reproduction apparatus for reproducing contents including multichannel sound data, and the like, which can be obtained through a recording medium, a network, a broadcasting system, etc.

2. Description of the Prior Art

Recently, there have been more opportunities to reproduce contents including multichannel sound data with, for example, DVDs (Digital Versatile Discs), digital television systems, etc. In a multichannel sound reproduction apparatus for reproducing multichannel sound, such as an AV (Audio Visual) theater system, or the like, it is preferable to deploy a plurality of loudspeakers at appropriate positions in order to obtain desirable realism. However, in many actual cases, loudspeakers cannot always be deployed at ideal positions due to the place where the reproduction system is installed or the structure of a room in which the reproduction system is installed. In view of such, the technique of forming a suitable sound field by adjusting the characteristics of sound which is to be reproduced through loudspeakers, such as phase characteristics, frequency characteristics, sound pressure level, etc., has been proposed. Further, the technique of automatically performing such an adjustment has been proposed wherein a microphone is placed at a predetermined position for collecting test sounds reproduced through loudspeakers such that a user is free from complicated adjustment effort (for example, Japanese Laid-Open Patent Publication No. 2002-330499).

However, the apparatus that performs automatic adjustments requires connecting a microphone, which is unnecessary for reproduction of multichannel sound, to the apparatus and placing the microphone at a predetermined position and is therefore lacking ease of use.

### SUMMARY OF THE INVENTION

An objective of the present invention is to automatically adjust the characteristics of sound which is to be reproduced without connecting a microphone to a reproduction apparatus or placing a microphone at a predetermined position.

To achieve the above objective, according to the present invention, a test sound reproduced through any one of loudspeakers is collected by another loudspeaker or a microphone integrally provided with another loudspeaker, and the characteristics of sound which is to be reproduced are controlled based on the sound collection result.

According to one aspect of the present invention, there is provided a multichannel sound reproduction apparatus for reproducing multichannel sound through a plurality of loudspeakers, comprising: a test sound signal output section for driving at least one loudspeaker to emit a test sound; a reception section for receiving a reception test sound signal generated according to the test sound collected by another loudspeaker or a microphone integrally provided with another loudspeaker; and a control section for controlling a multichannel sound signal which is to be output to each of the loudspeakers based on the reception test sound signal.

In one embodiment of the present invention, the multichannel sound reproduction apparatus further comprises an input/output switching section for selectively connecting each of the loudspeakers to the test sound signal output section or the reception section, wherein the test sound is collected by the loudspeaker connected to the reception section.

In one embodiment of the present invention, the test sound signal output section and the reception section perform emission and collection of a test sound a plurality of times while switching a loudspeaker for emitting the test sound and a loudspeaker or microphone for collecting the test sound.

In one embodiment of the present invention, the test sound signal output section sequentially or simultaneously drives the plurality of loudspeakers to emit test sounds; and the reception section receives a reception test sound signal generated according to each of the test sounds.

In one embodiment of the present invention, the control section includes: a delay time detection section for detecting a delay time of each of the test sounds; an interspeaker distance calculation section for calculating based on the delay time a distance between a loudspeaker which emits a test sound and a loudspeaker which collects the test sound; a loudspeaker position calculation section for calculating a two- or three-dimensional loudspeaker position of each loudspeaker based on the interspeaker distance; a listening distance calculation section for calculating a listening distance between each loudspeaker position and a predetermined listening position; and a delay time control section for controlling a delay time of a multichannel sound emitted by each loudspeaker based on the listening distance.

In one embodiment of the present invention, the control section further includes: a volume detection section for detecting a volume of a collected test sound; an output level calculation section for calculating an output level of each loudspeaker based on the detected volume and the interspeaker distance; and a volume control section for controlling based on the loudspeaker output level and the listening distance a volume of a multichannel sound which is to be emitted by each loudspeaker.

In one embodiment of the present invention, the multichannel sound reproduction apparatus further comprises a memory section for memorizing at least one set of parameters for controlling a delay time and volume of the multichannel sound.

In one embodiment of the present invention, the memory section memorizes a plurality of sets of parameters; and one of the plurality of sets of parameters is selected automatically or according to an user's instruction.

In one embodiment of the present invention, the parameters are selected according to a listening time.

In one embodiment of the present invention, the loudspeaker position calculation section is capable of setting a loudspeaker position of one or more loudspeakers in advance.

In one embodiment of the present invention, the multichannel sound reproduction apparatus further comprises a listening position entry section through which a user enters the predetermined listening position.

According to another aspect of the present invention, there is provided a multichannel sound adjustment method for adjusting multichannel sound reproduced through a plurality of loudspeakers, comprising the steps of: emitting a test sound through at least one loudspeaker; receiving a reception test sound signal generated according to the test sound collected by another loudspeaker or a microphone integrally provided with another loudspeaker; and controlling a multichannel sound signal which is to be output to each of the loudspeakers based on the reception test sound signal.

In one embodiment of the present invention, the step of controlling the multichannel sound signal includes controlling at least one of a delay time and volume of a multichannel sound emitted by each loudspeaker.

In one embodiment of the present invention, the step of emitting the test sound and the step of receiving the reception test sound signal are performed a plurality of times while switching a loudspeaker for emitting the test sound and a loudspeaker or microphone for detecting the test sound.

In one embodiment of the present invention, the step of emitting the test sound includes sequentially or simultaneously emitting test sounds through the plurality of loudspeakers; and the step of receiving the reception test sound signal includes outputting a reception test sound signal according to each of the test sounds.

### BRIEF DESCRIPTION OF THE DRAWINGS

FIG. 1 is a block diagram showing the structure of principal part of a multichannel sound reproduction apparatus 101.

FIG. 2 is a flowchart which illustrates an adjustment operation.

FIG. 3 is a flowchart which illustrates an adjustment operation.

FIG. 4 is a flowchart which illustrates an adjustment operation.

FIG. 5 is a flowchart which illustrates an adjustment operation.

FIG. 6 shows an example of the deployment of loudspeakers 110 to 115.

FIG. 7 shows an example of a presentation on a display 203 where a user designates a listening position 301.

### DESCRIPTION OF THE PREFERRED EMBODIMENTS

Hereinafter, a multichannel sound reproduction apparatus capable of reproducing 5.1ch (6ch) sound according to an embodiment of the present invention is described with reference to the drawings.

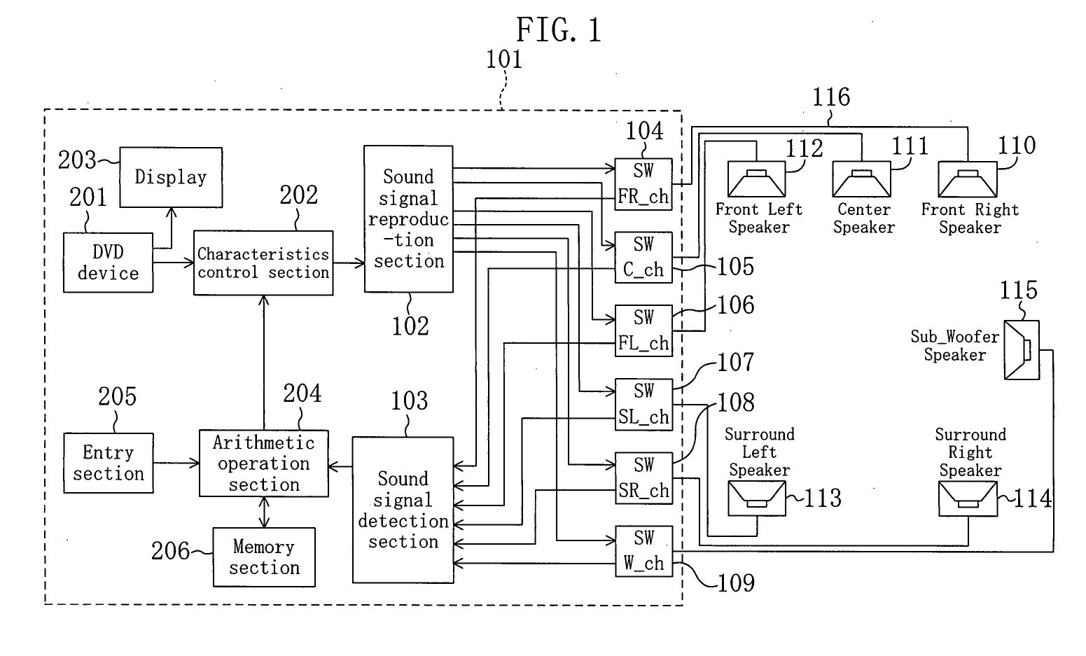

FIG. 1 is a block diagram showing the structure of principal part of a multichannel sound reproduction apparatus 101.

A sound signal reproduction section 102 outputs to loudspeakers a sound signal input from a DVD device 201 (described later) through a characteristics control section 202. The sound signal reproduction section 102 also outputs a predetermined test sound signal. The test sound signal is, for example, an impulse signal, although the present invention is not limited thereto.

A sound signal detection section 103 (reception section, delay time detection section, and volume detection section) receives a sound signal (reception test sound signal) output from a loudspeaker which functions as a microphone as will be described later to detect a propagation time (delay time) of a test sound, which lasts from emission of a test sound by any loudspeaker to reception of the test sound by another loudspeaker, and the sound pressure level (volume) of the received test sound.

Input/output switches 104 to 109 each switch the operation mode of a corresponding loudspeaker between the sound output mode and the sound input mode.

Loudspeakers 110 to 115 are a front right loudspeaker, a center loudspeaker, a front left loudspeaker, a surround left loudspeaker, a surround right loudspeaker, and a sub-woofer loudspeaker, respectively. The loudspeakers 110 to 115 are connected to the input/output switches 104 to 109 by loudspeaker cables 116.

The DVD device 201 is an example of a signal source of a multichannel sound signal and a video signal from which a video image is reproduced on a display 203. Alternatively, the signal source may be a reception device for receiving sound and video signals distributed through a network or a broadcasting system. Alternatively, the signal source may be a converter for converting a 2ch sound signal to a pseudo multichannel sound signal.

The characteristics control section 202 (delay time control section and volume control section) controls the delay time and signal level (volume) of a sound signal input from the DVD device 201.

An arithmetic operation section 204 (interspeaker distance calculation section, loudspeaker position calculation section, listening distance calculation section, and output level calculation section) calculates the position and output level of each of the loudspeakers 110 to 115 based on the propagation time and the sound pressure level detected by the sound signal detection section 103. The arithmetic operation section 204 notifies the characteristics control section 202 about the delay time and the signal level based on the positions and output levels of the loudspeakers 110 to 115 and a listening position entered by a user at an entry section 205.

A memory section 206 memorizes the positions and output levels of the loudspeakers 110 to 115 and the listening position or the delay time and signal level about which the characteristics control section 202 is notified. The memory section 206 may memorize a plurality of sets of these information such that a set of information can be read from them according to a user's instruction or viewing time. More specifically, in the case where the listening environment of a room in which the apparatus of the present invention is installed differs with the passage of time (for example, curtains are open during the daytime but closed during the nighttime), one of a plurality of sets of information may be selected according to the listening time. With such a feature, desirable realism is automatically obtained even when the indoor listening environment differs between day and night.

The sound signal detection section 103, the characteristics control section 202 and the arithmetic operation section 204 constitute a reception section for receiving a reception test sound signal generated according to a test sound collected by loudspeakers other than one that has emitted the test sound and a control section for controlling a multichannel sound signal which is to be output to each loudspeaker based on the reception test sound signal.

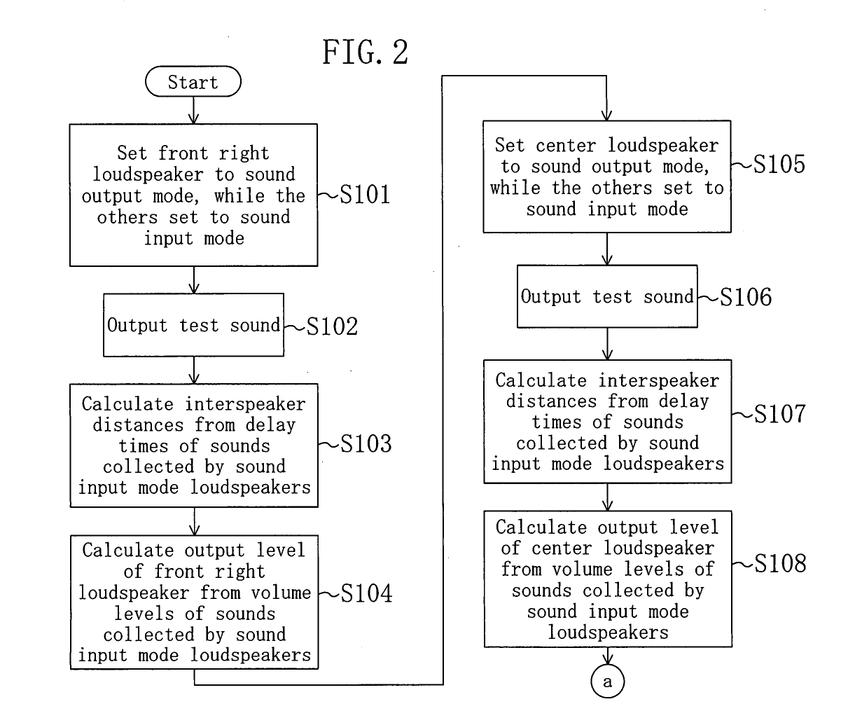

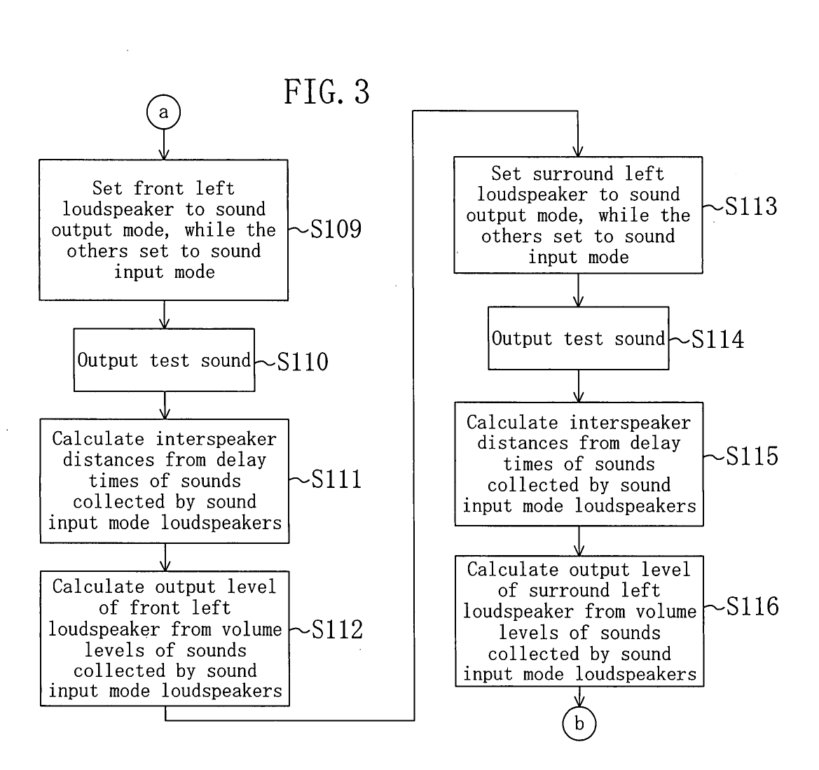

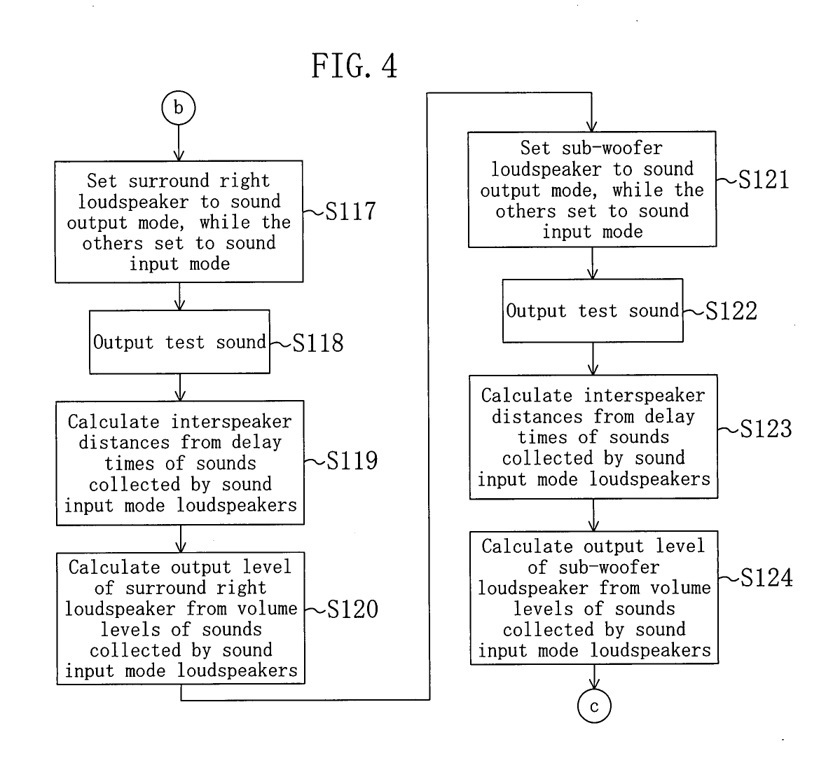

In the multichannel sound reproduction apparatus 101 having the above-described structure, reproduction sound is adjusted as described below and as illustrated in FIGS. 2 to FIG. 5.

(S101) The input/output switch 104 switches the operation mode of the front right loudspeaker 110 to the sound output mode, while the other input/output switches 105 to 109 switch the operation mode of the corresponding loudspeakers to the sound input mode.

(S102) The sound signal reproduction section 102 outputs a test sound signal to the front right loudspeaker 110.

(S103) The sound signal detection section 103 detects (measures) the propagation time of the test sound collected by each of the loudspeakers 111 to 115. The arithmetic operation section 204 calculates the distance between the front right loudspeaker 110 and each of the other loudspeakers 111 to 115 from the propagation time and sound velocity (about 340 m/s). In the case where it is unnecessary to determine the absolute distance, the value of the propagation time may be used as the value of the distance without consideration for the sound velocity.

(S104) The sound signal detection section 103 detects (measures) the sound pressure level of the test sound collected by each of the loudspeakers 111 to 115. The arithmetic operation section 204 calculates the output level of the front right loudspeaker 110 from the sound pressure level and the distance between the loudspeakers (interspeaker distance).

(S105 to S108) In the same way as that described above, a test sound is emitted by the center loudspeaker 111 and collected by the other loudspeakers, and the distance between the center loudspeaker 111 and each of the other loudspeakers and the output level of the center loudspeaker 111 are calculated.

(S109 to S112) In the same way as that described above, a test sound is emitted by the front left loudspeaker 112 and collected by the other loudspeakers, and the distance between the front left loudspeaker 112 and each of the other loudspeakers and the output level of the front left loudspeaker 112 are calculated.

(S113 to S116) In the same way as that described above, a test sound is emitted by the surround left loudspeaker 113 and collected by the other loudspeakers, and the distance between the surround left loudspeaker 113 and each of the other loudspeakers and the output level of the surround left loudspeaker 113 are calculated.

(S117 to S120) In the same way as that described above, a test sound is emitted by the surround right loudspeaker 114 and collected by the other loudspeakers, and the distance between the surround right loudspeaker 114 and each of the other loudspeakers and the output level of the surround right loudspeaker 114 are calculated.

(S121 to S124) In the same way as that described above, a test sound is emitted by the sub-woofer loudspeaker 115 and collected by the other loudspeakers, and the distance between the sub-woofer loudspeaker 115 and each of the other loudspeakers and the output level of the sub-woofer loudspeaker 115 are calculated.

In the above example, the distance between any two of the loudspeakers is measured twice. The two measured values may be averaged for improving the accuracy. Alternatively, the number of times of detection may be decreased. Further, the directivity of the loudspeakers 110 to 115 may be considered in the calculation of the output level.

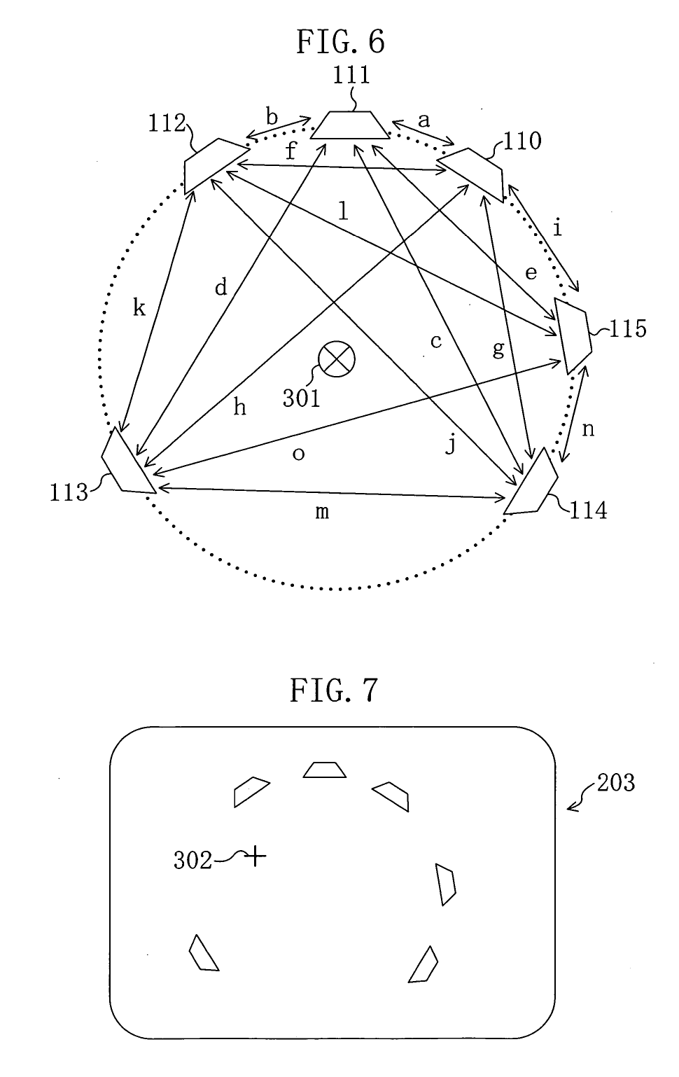

In the following descriptions, the interspeaker distances are represented by “a” to “o” as shown in FIG. 6:
a: Distance between Center loudspeaker 111 and Front right loudspeaker 110;
b: Distance between Center loudspeaker 111 and Front left loudspeaker 112;
c: Distance between Center loudspeaker 111 and Surround right loudspeaker 114;
d: Distance between Center loudspeaker 111 and Surround left loudspeaker 113;
e: Distance between Center loudspeaker 111 and Sub-woofer loudspeaker 115;
f: Distance between Front right loudspeaker 110 and Front left loudspeaker 112;
g: Distance between Front right loudspeaker 110 and Surround right loudspeaker 114;
h: Distance between Front right loudspeaker 110 and Surround left loudspeaker 113;
i: Distance between Front right loudspeaker 110 and Sub-woofer loudspeaker 115;
j: Distance between Front left loudspeaker 112 and Surround right loudspeaker 114;
k: Distance between Front left loudspeaker 112 and Surround left loudspeaker 113;
l: Distance between Front left loudspeaker 112 and Sub-woofer loudspeaker 115;
m: Distance between Surround right loudspeaker 114 and Surround left loudspeaker 113;
n: Distance between Surround right loudspeaker 114 and Sub-woofer loudspeaker 115;
o: Distance between Surround left loudspeaker 113 and Sub-woofer loudspeaker 115.

The positions where the loudspeakers are installed are represented by three-dimensional coordinates as follows:

(xfr, yfr, zfr): Front right loudspeaker 110;

(xc, yc, zc): Center loudspeaker 111;

(xfl, yfl, zfl): Front left loudspeaker 112;

(xsr, ysr, zsr): Surround right loudspeaker 114;

(xsl, ysl, zsl): Surround left loudspeaker 113;

(xsw, ysw, zsw): Sub-woofer loudspeaker 115.

With the above installation positions, the relationships between the coordinate values and the interspeaker distances are as follows:
(xc−xfr)²+(yc−yfr)²+(zc−zfr)²=a² (Expression 1)
(xc−xfl)²+(yc−yfl)²+(zc−zfl)²=b² (Expression 2)
(xc−xsr)²+(yc−ysr)²+(zc−zsr)²=c² (Expression 3)
(xc−xsl)²+(yc−ysl)²+(zc−zsl)²=d² (Expression 4)
(xc−xsw)²+(yc−ysw)²+(zc−zsw)²=e² (Expression 5)
(xfr−xfl)²+(yfr−yfl)²+(zfr−zfl)²=f² (Expression 6)
(xfr−xsr)²+(yfr−ysr)²+(zfr−zsr)²=g² (Expression 7)
(xfr−xsl)²+(yfr−ysl)²+(zfr−zsl)²=h² (Expression 8)
(xfr−xsw)²+(yfr−ysw)²+(zfr−zsw)²=i² (Expression 9)
(xfl−xsr)²+(yfl−ysr)²+(zfl−zsr)²=j² (Expression 10)
(xfl−xsl)²+(yfl−ysl)²+(zfl−zsl)²=k² (Expression 11)
(xfl−xsw)²+(yfl−ysw)²+(zfl−zsw)²=l² (Expression 12)
(xsr−xsl)²+(ysr−ysl)²+(zsr−zsl)²=m² (Expression 13)
(xsr−xsw)²+(ysr−ysw)²+(zsr−zsw)²=n² (Expression 14)
(xsl−xsw)²+(ysl−ysw)²+(zsl−zsw)²=o² (Expression 15)

Although there are 18 coordinate values of the loudspeakers, the coordinate system may be determined arbitrarily. For example, 6 out of the following coordinate values may be constants:
(xc, yc, zc)=(0, 0, 0)
(xfr, yfr, zfr)=(xfr, 0, 0)
(xfl, yfl, zfl)=(xfl, yfl, 0)
In this case, the coordinate system is set such that the position of the center loudspeaker 111 is at the origin, the position of the front right loudspeaker 110 is on the x axis, and the position of the front left loudspeaker 112 is on the plane of “z=0”.

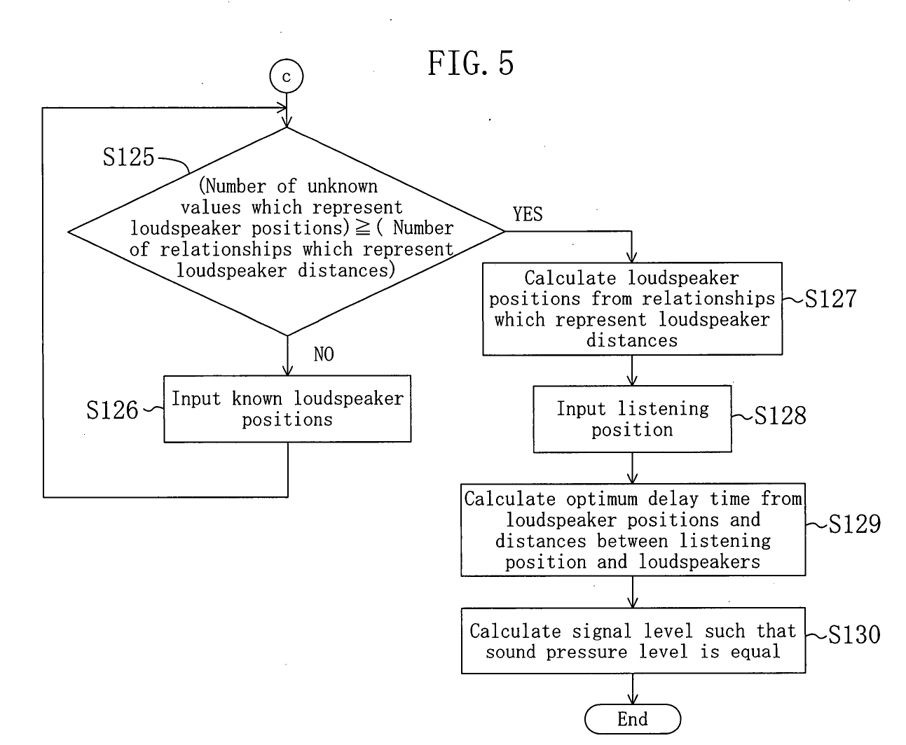

Therefore, 12 coordinate values are unknown. The positions of all the loudspeakers can be determined using 12 out of the 15 expressions shown above. Although only 12 interspeaker distances may be measured, it is possible that 15 distances are measured and, when a coordinate value does not result in one value, the error is distributed to relevant coordinates. In the case where measurement of the interspeaker distances cannot be appropriately carried out or where the arithmetic operation section 204 is set in advance to measure less than 12 interspeaker distances, a user may set the positions of some loudspeakers through, for example, the processes of steps S125 and S126 of FIG. 5.

(S125) It is determined whether or not the number of unknown coordinate values is equal to or greater than the number of measured distances. If Yes, the positions of the loudspeakers are calculated at step S127. If No, the operation proceeds to step S126.

(S126) The entry section 205 receives the position setting of any loudspeaker which is determined by the user. For example, in general, the front right loudspeaker 110 and the front left loudspeaker 112 are placed at the right and left sides of a video monitor (e.g., the display 203), while the center loudspeaker 111 is placed on or under the video monitor. In this case, for example, the positions of these loudspeakers 110 to 112 are:
(xc, yc, zc)=(0, 0, 1)
(xfr, yfr, zfr)=(1, 0, 0)
(xfl, yfl, zfl)=(−1, 0, 0)
Setting of the positions of the loudspeakers is not limited to any particular method. For example, the coordinate values may be input with numeric keys. Alternatively, the loudspeaker position may be designated through a touch panel. Still alternatively, the loudspeaker position may be designated by moving a pointer shown on the display 203 in the same manner as the designation of the listening position, which will be described later.

(S127) The arithmetic operation section 204 calculates the positions of the loudspeakers based on all or some of the above relationships (Expressions 1 to 15).

(S128) The entry section 205 receives the listening position 301 designated by the user. Specifically, for example, as shown in FIG. 7, the positions of the loudspeakers 110 to 115 are shown together with a pointer 302 on the display 203. The user uses cursor keys of an unshown remote controller to move the pointer 302 for designating the listening position 301. Alternatively, the user may physically designate the listening position 301. Specifically, for example, the user makes any sound at the listening position 301, and the multichannel sound reproduction apparatus 101 determines the listening position 301 based on a difference among the loudspeakers 110 to 115 in timing of collecting the sound made by the user.

(S129) The arithmetic operation section 204 calculates the distances between the loudspeakers 110 to 115 and the listening position 301 (listening distances) based on the positions of the loudspeakers 110 to 115 and the listening position. The delay time is determined according to the difference among the calculated distances such that sound emitted by the loudspeakers 110 to 115 reach the listening position 301 at the same time. The determined delay time is input to the characteristics control section 202 and stored in the memory section 206.

(S130) The arithmetic operation section 204 determines the signal level such that the sound pressure level is equal among the sounds reaching the listening position 301 from the loudspeakers 110 to 115 based on the output levels and listening distances of the loudspeakers 110 to 115. The determined signal level is input to the characteristics control section 202 and stored in the memory section 206.

It should be noted that the information stored in the memory section 206 are not limited to the delay time and signal level themselves but may be parameters from which the delay time and signal level can be determined.

After the above-described adjustment, for example, reproduction sound signals for the loudspeakers 110 to 115 are input from the DVD device 201 to the characteristics control section 202. The characteristics control section 202 delays each of the reproduction sound signals according to the designated delay time and signal level corresponding thereto and converts (amplifies) the signal level. The resultant reproduction sound signal is output to the sound signal reproduction section 102. As a result, a sound field optimum for listening at the listening position 301 is formed.

Although in the above example the positions of the loudspeakers 110 to 115 are mapped in the three-dimensional space, if the loudspeakers 110 to 115 are placed at substantially the same height, the positions of the loudspeakers 110 to 115 may be mapped in the two-dimensional space with the following coordinates, for example:

(xfr, yfr): Front right loudspeaker 110;

(xc, yc): Center loudspeaker 111;

(xfl, yfl): Front left loudspeaker 112;

(xsr, ysr): Surround right loudspeaker 114;

(xsl, ysl): Surround left loudspeaker 113;

(xsw, ysw): Sub-woofer loudspeaker 115.

In this case, the arithmetic operation process is greatly simplified, and the frequency of requiring entry of the loudspeaker positions by the user is reduced.

In the above-described example, the loudspeakers 110 to 115 are switched by the input/output switches 104 to 109 to function as microphones, but the present invention is not limited thereto. For example, a microphone may be provided integrally with each of the loudspeakers 110 to 115. Also in this case, at every sound adjustment, the characteristics of sound which is to be reproduced can be automatically adjusted without a necessity to connect a separate microphone to the multichannel sound reproduction apparatus or place a separate microphone at a predetermined position. In the case where such a microphone is provided, the sound pressure level of each of the loudspeakers 110 to 115 can be detected only with a combination of each of the loudspeakers 110 to 115 and a corresponding microphone.

The test sound signal is not limited to the impulse signal but may be a sinusoidal signal, a noise signal, a general non-periodic sound signal, or the like. Even in the case of a general sound signal, a phase difference (propagation time) can readily be detected by comparing the waveform of a signal output from the sound signal reproduction section 102 and the waveform of a signal detected by the sound signal detection section 103.

Alternatively, for example, test sounds having different frequencies may be simultaneously emitted through a plurality of loudspeakers. In this case, the time of the entire adjustment process is shortened.

The adjustable parameters are not limited to the delay time and signal level, but only one of these parameters may be adjusted. Alternatively, the frequency characteristic, the echo, etc., may be adjustable together with, or in place of, the delay time and/or signal level.

Although the above-described example is a multichannel sound reproduction apparatus capable of reproducing 5.1ch (6ch) sound, the present invention is applicable to various multichannel sound reproduction apparatuses capable of sound reproduction of 3 or more channels.

What is claimed is:

1. A multichannel sound reproduction apparatus for reproducing multichannel sound through a plurality of loudspeakers, comprising:
a test sound signal output section for driving at least one loudspeaker to emit a test sound;
a reception section for receiving a reception test sound signal generated according to the test sound collected by another loudspeaker or a microphone integrally provided with another loudspeaker; and
a control section for controlling a multichannel sound signal which is to be output to each of the loudspeakers based on the reception test sound signal.

2. The multichannel sound reproduction apparatus of claim 1, further comprising an input/output switching section for selectively connecting each of the loudspeakers to the test sound signal output section or the reception section,
wherein the test sound is collected by the loudspeaker connected to the reception section.

3. The multichannel sound reproduction apparatus of claim 1, wherein the test sound signal output section and the reception section perform emission and collection of a test sound a plurality of times while switching a loudspeaker for emitting the test sound and a loudspeaker or microphone for collecting the test sound.

4. The multichannel sound reproduction apparatus of claim 1, wherein:
the test sound signal output section sequentially or simultaneously drives the plurality of loudspeakers to emit test sounds; and
the reception section receives a reception test sound signal generated according to each of the test sounds.

5. The multichannel sound reproduction apparatus of claim 4, wherein the control section includes:
a delay time detection section for detecting a delay time of each of the test sounds;
an interspeaker distance calculation section for calculating based on the delay time a distance between a loudspeaker which emits a test sound and a loudspeaker which collects the test sound;
a loudspeaker position calculation section for calculating a two- or three-dimensional loudspeaker position of each loudspeaker based on the interspeaker distance;
a listening distance calculation section for calculating a listening distance between each loudspeaker position and a predetermined listening position; and
a delay time control section for controlling a delay time of a multichannel sound emitted by each loudspeaker based on the listening distance.

6. The multichannel sound reproduction apparatus of claim 5, wherein the control section further includes:
a volume detection section for detecting a volume of a collected test sound;
an output level calculation section for calculating an output level of each loudspeaker based on the detected volume and the interspeaker distance; and
a volume control section for controlling based on the loudspeaker output level and the listening distance a volume of a multichannel sound which is to be emitted by each loudspeaker.

7. The multichannel sound reproduction apparatus of claim 6, further comprising a memory section for memorizing at least one set of parameters for controlling a delay time and volume of the multichannel sound.

8. The multichannel sound reproduction apparatus of claim 7, wherein:
the memory section memorizes a plurality of sets of parameters; and
one of the plurality of sets of parameters is selected automatically or according to an user's instruction.

9. The multichannel sound reproduction apparatus of claim 8, wherein the parameters are selected according to a listening time.

10. The multichannel sound reproduction apparatus of claim 5, wherein the loudspeaker position calculation section is capable of setting a loudspeaker position of one or more loudspeakers in advance.

11. The multichannel sound reproduction apparatus of claim 5, further comprising a listening position entry section through which a user enters the predetermined listening position.

12. A multichannel sound adjustment method for adjusting multichannel sound reproduced through a plurality of loudspeakers, comprising the steps of:
emitting a test sound through at least one loudspeaker;
receiving a reception test sound signal generated according to the test sound collected by another loudspeaker or a microphone integrally provided with another loudspeaker; and
controlling a multichannel sound signal which is to be output to each of the loudspeakers based on the reception test sound signal.

13. The multichannel sound adjustment method of claim 12, wherein the step of controlling the multichannel sound signal includes controlling at least one of a delay time and volume of a multichannel sound emitted by each loudspeaker.

14. The multichannel sound adjustment method of claim 12, wherein the step of emitting the test sound and the step of receiving the reception test sound signal are performed a plurality of times while switching a loudspeaker for emitting the test sound and a loudspeaker or microphone for detecting the test sound.

15. The multichannel sound adjustment method of claim 12, wherein:
the step of emitting the test sound includes sequentially or simultaneously emitting test sounds through the plurality of loudspeakers; and
the step of receiving the reception test sound signal includes receiving a reception test sound signal according to each of the test sounds.
